(19) United States
(12) Patent Application Publication
(10) Pub. No.: US 2026/0145667 A1
(43) Pub. Date: May 28, 2026

(54) MANAGEMENT SYSTEM AND AUTOMATED VALET PARKING SYSTEM

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/395,828

(22) Filed: Nov. 20, 2025

(30) Foreign Application Priority Data
Nov. 25, 2024 (JP) 2024-204580

(51) Int. Cl. B60W 30/06; B60W 50/14

(52) U.S. Cl. CPC B60W 30/06; B60W 50/14; B60W 2050/146

(57) ABSTRACT

An automated valet parking system includes: a vehicle that is a target of automated valet parking in a parking lot; and a terminal. The terminal includes at least one of a user terminal of a user of the vehicle and an infrastructure terminal installed in the parking lot. In response to a request regarding the automated valet parking of the vehicle from the user, the vehicle performs a first reaction, and the terminal performs a second reaction.

### CROSS-REFERENCES TO RELATED APPLICATION

The present disclosure claims priority to Japanese Patent Application No. 2024-204580, filed on Nov. 25, 2024, the contents of which application are incorporated herein by reference in their entirety.

### TECHNICAL FIELD

The present disclosure relates to automated valet parking (AVP: Automated Valet Parking) of a vehicle in a parking lot.

### BACKGROUND ART

Patent Literature 1 discloses automated valet parking in a parking lot. A vehicle that supports the automated valet parking acquires route information from a parking lot system and autonomously travels along the acquired route.

### List of Related Art

Patent Literature 1: German Patent Application Publication No. 102012222562

### SUMMARY

Automated valet parking in a parking lot is considered. A user of the automated valet parking may issue a request to an automated valet parking system. In that case, if the user is unable to know whether the automated valet parking system receives the request, the user may achieve a sense of anxiety.

A first aspect relates to a management system that manages automated valet parking of a vehicle in a parking lot.

A terminal includes at least one of a user terminal of a user of the vehicle and an infrastructure terminal installed in the parking lot.

The management system includes one or more processors. The one or more processors receive a request regarding the automated valet parking of the vehicle from the user terminal. In response to the request, the one or more processors instruct the vehicle to perform a first reaction and instruct the terminal to perform a second reaction.

A second aspect relates to an automated valet parking system.

The automated valet parking system includes: a vehicle that is a target of automated valet parking in a parking lot; and a terminal.

The terminal includes at least one of a user terminal of a user of the vehicle and an infrastructure terminal installed in the parking lot.

In response to a request regarding the automated valet parking of the vehicle from the user, the vehicle performs a first reaction, and the terminal performs a second reaction.

According to the present disclosure, in response to the request from the user, the vehicle performs the first reaction and the terminal performs the second reaction. When the user is looking at the vehicle, the user is able to notice the first reaction of the vehicle. Even if the user is not looking at the vehicle, the user is likely to notice the second reaction of the terminal. That is, certainty that the user recognizes the reaction is improved. The user recognizing the reaction is able to recognize that the automated valet parking system has received the request. As a result, the user achieves a sense of relief and increases confidence in the automated valet parking system.

### BRIEF DESCRIPTION OF DRAWINGS

FIG. 1 is a conceptual diagram illustrating an overview of an automated valet parking system (AVP system);

FIG. 2 is a conceptual diagram for explaining an example of automated valet parking;

FIG. 3 is a conceptual diagram for explaining an example of a request from a user of the AVP and a reaction thereto;

FIG. 4 is a conceptual diagram for explaining an example of a first reaction performed by a vehicle and a second reaction performed by a terminal;

FIG. 5 is a conceptual diagram for explaining various examples of linkage between a first reaction performed by a vehicle and a second reaction performed by a terminal;

FIG. 6 is a conceptual diagram for explaining a first example of supplementary information;

FIG. 7 is a conceptual diagram for explaining a second example of supplementary information;

FIG. 8 is a block diagram showing an example of a configuration of a vehicle;

FIG. 9 is a block diagram showing an example of a configuration of a user terminal;

FIG. 10 is a block diagram showing an example of a configuration of a back-end system; and

FIG. 11 is a block diagram showing an example of a configuration of a parking lot system.

### DETAILED DESCRIPTION

Embodiments of the present disclosure will be described with reference to the accompanying drawings. In the following description, automated valet parking may be referred to as “AVP”.

### 1. Automated Valet Parking System (AVP System)

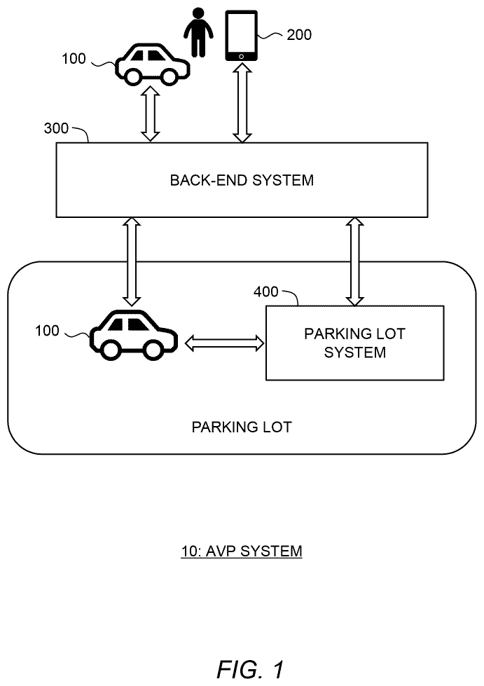

FIG. 1 is a conceptual diagram illustrating an overview of an AVP system 10 according to the present embodiment. The AVP system 10 is a system for the AVP in a parking lot. The AVP system 10 includes a vehicle 100, a user terminal 200, a back-end system 300, and a parking lot system 400.

The vehicle 100 is a target of the AVP in the parking lot. The vehicle 100 has a function of autonomously traveling at least in the parking lot.

The user terminal 200 is a terminal operated by a user of the AVP service, that is, a user of the vehicle 100. Examples of the user terminal 200 include a smartphone and a PC.

The back-end system 300 manages the AVP in one or more parking lots, users of the AVP service, and the like. The parking lot system 400, which is an infrastructure system installed in a parking lot, manages the AVP in the parking lot. The back-end system 300 and the parking lot system 400 may be collectively referred to as a “management system.” The management system manages the AVP in the parking lot.

The vehicle 100 and the back-end system 300 can communicate with each other. For example, the vehicle 100 and the back-end system 300 communicate with each other using a mobile communication service. In the parking lot, the vehicle 100 and the parking lot system 400 can perform a wireless communication with each other. For example, the vehicle 100 and the parking lot system 400 perform a wireless communication with each other using a wireless LAN. Moreover, the user terminal 200 and the back-end system 300 can communicate with each other. For example, the user terminal 200 and the back-end system 300 communicate with each other using a mobile communication service. Further, the back-end system 300 and the parking lot system 400 may communicate with each other in a wired or wireless manner.

An example of a flow of a reservation of the AVP service is as follows. It is assumed that member information of the users is registered in advance in the back-end system 300. First, a user makes a reservation of the AVP. For example, the user operates the user terminal 200 to input ID information of the user, a desired parking lot, a desired date of use, a desired time of use (i.e, a scheduled entry time and a scheduled exit time), and the like. The user terminal 200 transmits reservation request information including the input information to the back-end system 300. The back-end system 300 executes reservation processing based on the reservation request information, and sends a reservation completion notification to the user terminal 200. In addition, the back-end system 300 provides reservation information to the parking lot system 400 of the reserved parking lot.

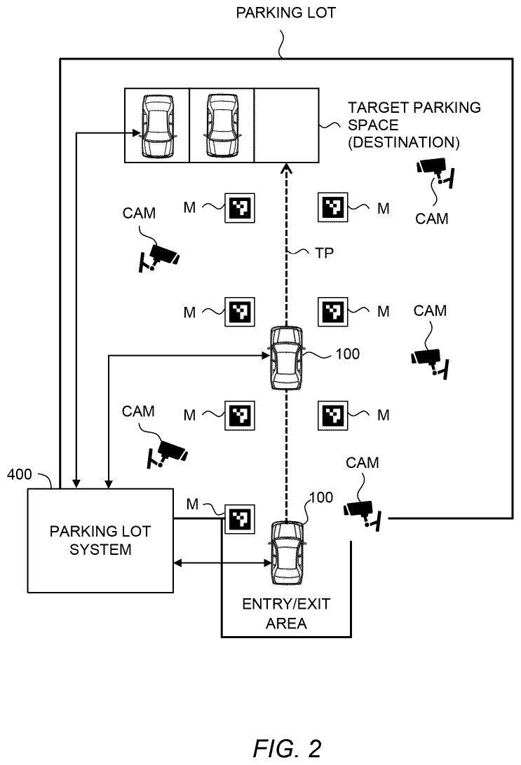

FIG. 2 is a conceptual diagram for explaining an example of the AVP in the parking lot.

The vehicle 100 recognizes a situation around the vehicle 100 by using a recognition sensor (for example, a camera) mounted on the vehicle 100. The vehicle 100 travels safely while recognizing the surrounding situation. A plurality of markers M (landmarks) may be arranged in the parking lot. The marker M is used for guiding the vehicle 100 in the parking lot. For example, the vehicle 100 acquires an image of the surroundings using the camera, and recognizes the marker M based on the image. Then, based on a result of recognition of the marker M, the vehicle 100 performs localization processing that estimates a position of the vehicle 100 in the parking lot with high accuracy. The vehicle 100 automatically travels in the parking lot based on the estimated vehicle position.

One or more infrastructure cameras CAM may be installed in the parking lot. The infrastructure camera CAM captures an image of the parking lot and acquires an image showing a situation of the parking lot. The parking lot system 400 communicates with the infrastructure camera CAM to acquire the image captured by the infrastructure camera CAM. The parking lot system 400 analyzes the image to detect the vehicle 100 shown in the image. Moreover, the parking lot system 400 estimates a position of the vehicle 100 shown in the image. Further, the parking lot system 400 manages the vehicle 100 in the parking lot based on the position of the vehicle 100. The parking lot system 400 may provide the vehicle 100 with the position information of the vehicle 100. The vehicle 100 may automatically travel in the parking lot based on the position information provided from the parking lot system 400.

An example of an entry process (check-in) is as follows. The vehicle 100 stops at an entry area. At the entry area, the user gets off the vehicle 100 and requests the entry by using the user terminal 200 or the like. The management system (i.e., at least one of the back-end system 300 and the parking lot system 400) conducts authentication of the user and the vehicle 100. Upon completion of the authentication, authority to operate the vehicle 100 is transferred from the user to the management system. The management system communicates with the vehicle 100 and activates the vehicle 100. Moreover, the parking lot system 400 allocates an available parking space to the vehicle 100. The allocated available parking space is a target parking space, that is, a destination for the vehicle 100 at the time of the entry. Further, the parking lot system 400 sets a travel path TP (a target trajectory) from the entry area to the target parking space in the parking lot. The parking lot system 400 sends an entry instruction to the vehicle 100. The entry instruction includes information on the target parking space and the travel path TP. In response to the entry instruction, the vehicle 100 automatically travels to the target parking space along the travel path TP. That is, the vehicle 100 automatically travels so as to follow the travel path TP based on the vehicle position. Then, the vehicle 100 is automatically parked in the target parking space. Upon completion of the parking, the management system instructs the vehicle 100 to stop the operation.

An example of an exit process (check-out) is as follows. The user requests the exit by using the user terminal 200 or the like. The management system communicates with the vehicle 100 and activates the vehicle 100. At the time of exit, a designated exit area is a destination for the vehicle 100. The parking lot system 400 sets a travel path TP (a target trajectory) from the parking space to the exit area in the parking lot. The parking lot system 400 sends an exit instruction to the vehicle 100. The exit instruction includes information on the designated exit area and the travel path TP. In response to the exit instruction, the vehicle 100 automatically travels to the exit area along the travel path TP. That is, the vehicle 100 automatically travels so as to follow the travel path TP based on the vehicle position. Then, the vehicle 100 automatically stops the vehicle 100 in the exit area. The authority to operate the vehicle 100 is transferred from the management system to the user. The user gets on the vehicle 100. The vehicle 100 starts moving to a next destination.

### 2. Reaction to Request From User

A user of the AVP may issue a request regarding the AVP to the AVP system 10. In that case, if the user is unable to know whether or not the AVP system 10 normally receives the request, the user may achieve a sense of anxiety. That is, if there is no reaction to the request from the user, the user may achieve a sense of anxiety. In view of the above, the AVP system 10 according to the present embodiment is configured to perform a reaction (answer back) in response to the request regarding the AVP from the user.

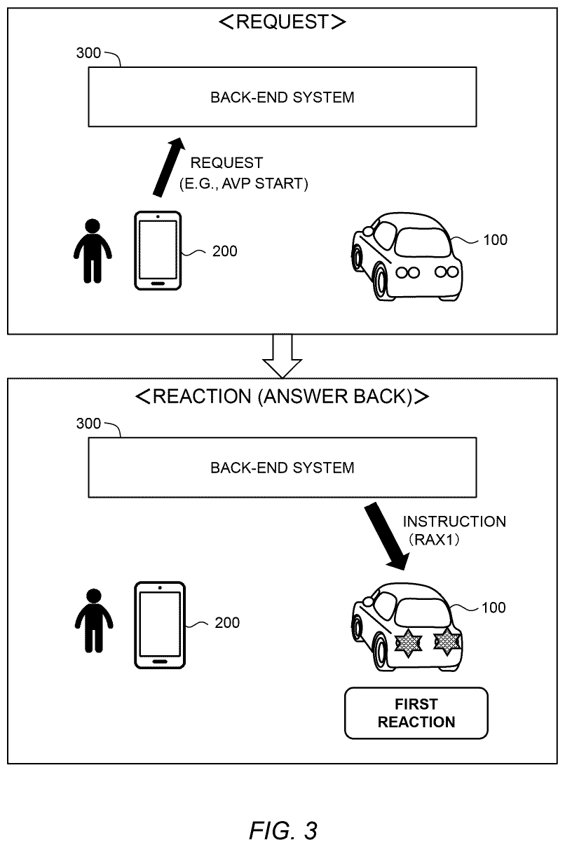

FIG. 3 is a conceptual diagram for explaining an example of the request from the user of the AVP and the reaction thereto.

For example, at the entry area, the user gets off the vehicle 100 and requests for starting the AVP by the use of the user terminal 200 or the like. For example, the user opens an AVP application on the user terminal 200. An “AVP Start” button is displayed on a display of the user terminal 200. When the user taps the “AVP Start” button, an AVP start request is transmitted from the user terminal 200 to the back-end system 300. Upon receiving the AVP start request, the back-end system 300 communicates with the vehicle 100 to check if a state of the vehicle 100 satisfies an AVP start condition. The AVP start condition includes, for example, that the vehicle 100 is in an ignition-OFF state, that a window is closed, that a door is closed and locked, and the like. When the state of the vehicle 100 does not satisfy the AVP start condition, the back-end system 300 rejects the AVP start request. On the other hand, when the state of the vehicle 100 satisfies the AVP start condition, the back-end system 300 accepts the AVP start request and proceeds to start the AVP.

Here, if the user is unable to know whether or not the avp system 10 normally receives the AVP start request, the user may achieve a sense of anxiety. That is, if there is no reaction to the AVP start request after the transmission of the AVP start request, the user may achieve a sense of anxiety. In addition, if the AVP of the vehicle 100 suddenly starts without any reaction after the transmission of the AVP start request, the user may be surprised at the sudden commencement of the AVP.

In view of the above, upon receiving the AVP start request, the back-end system 300 communicates with the vehicle 100 and instructs the vehicle 100 to make a predetermined reaction. In other words, in response to the AVP start request, the back-end system 300 communicates with the vehicle 100 and instructs the vehicle 100 to perform a predetermined reaction.

A reaction is defined by a combination of a device executing the reaction, a pattern of an operation of the device, and a duration of the operation of the device. Examples of the device executing the reaction include a light, an actuator, a horn, and the like. Examples of the light include a blinker (a direction indicator), a headlight, a brake light, a fog light, and the like. Examples of the actuator include a wiper actuator that operates a wiper, an actuator for automatically opening and closing a side mirror, and the like.

Examples of a visible reaction include blinking a light, operating a wiper, opening and closing a side mirror, and the like. Examples of an audible reaction include sounding a horn, and the like. For example, the light blinks in a predetermined pattern for a predetermined period of time (e.g., a few seconds). As another example, a side mirror may open and close in a predetermined pattern for a predetermined period of time. As still another example, the horn may sound in a predetermined pattern for a predetermined period of time.

The reaction performed by the vehicle 100 is hereinafter referred to as a “first reaction”. In response to the AVP start request from the user, the back-end system 300 communicates with the vehicle 100 and instructs the vehicle 100 to perform the first reaction. More specifically, the back-end system 300 transmits first reaction information RAX1 instructing the first reaction to the vehicle 100. The first reaction information RAX1 may include a content (i.e., type, pattern, and duration) of the first reaction. Typically, the content of the first reaction is determined in advance. The vehicle 100 receives the first reaction information RAX1 from the back-end system 300. The vehicle 100 performs the first reaction in accordance with the first reaction information RAX1. That is, the vehicle 100 performs the first reaction in response to the AVP start request from the user. This allows the user to recognize that the AVP system 10 normally receives the AVP start request. As a result, the user achieves a sense of relief and increases confidence in the AVP system 10.

The content of the first reaction may be set differently depending on whether the AVP start request is accepted or not. For example, the first reaction when the AVP start request is accepted may be blinking a light, and the first reaction when the AVP start request is rejected may be operating a wiper. As another example, the first reaction is blinking a light, and a pattern of blinking the light may be different between when the AVP start request is accepted and when the AVP start request is rejected.

It should be noted that the AVP start request and the first reaction to the AVP start request have been described above just as an example. The request regarding the AVP is not limited to the AVP start request. In addition, the entity that instructs the vehicle 100 to perform the first reaction is not limited to the back-end system 300. The parking lot system 400 may instruct the vehicle 100 to perform the first reaction.

To generalize, in response to a request regarding the AVP from the user, the management system (i.e., at least one of the back-end system 300 and the parking lot system 400) communicates with the vehicle 100 and instructs the vehicle 100 to perform the first reaction. More specifically, the management system transmits the first reaction information RAX1 instructing the first reaction to the vehicle 100. The vehicle 100 performs the first reaction in accordance with the first reaction information RAX1. That is, the vehicle 100 performs the first reaction in response to the request regarding the AVP from the user. This allows the user to recognize that the AVP system 10 normally receives the request. As a result, the user achieves a sense of relief and increases confidence in the AVP system 10.

### 3. Linkage Between Vehicle and Terminal

As described above, the vehicle 100 performs the first reaction in response to the request regarding the AVP from the user. However, if the user is not looking at the vehicle 100, the user may not notice the first reaction performed by the vehicle 100. In view of the above, not only the vehicle 100 performs the first reaction but also a terminal (for example, the user terminal 200) different from the vehicle 100 may perform a second reaction. In other words, the vehicle 100 and the terminal may link (cooperate) with each other to perform the first reaction and the second reaction, respectively.

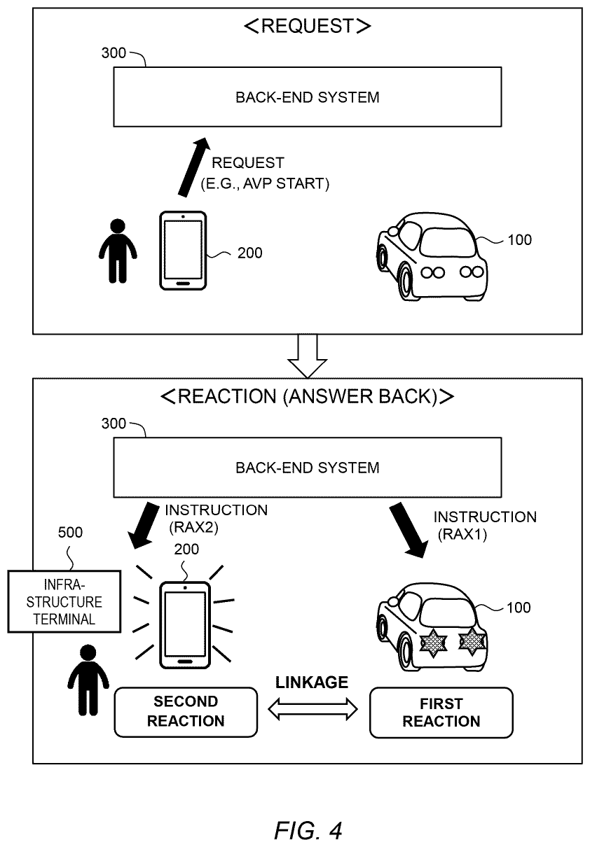

FIG. 4 is a conceptual diagram for describing an example of the first reaction performed by the vehicle 100 and the second reaction performed by the terminal. The terminal is, for example, the user terminal 200 of the user. As another example, the terminal may be an infrastructure terminal 500 installed in the parking lot. The infrastructure terminal 500 is an AVP-dedicated terminal included in the parking lot system 400. The infrastructure terminal 500 has the same functions as the user terminal 200. The terminal may include both the user terminal 200 and the infrastructure terminal 500. Examples of the second reaction performed by the terminal include blinking a light (e.g., a display), generating vibration, outputting a sound, and the like.

For example, at the entry area, the user requests for starting the AVP by the use of the user terminal 200 or the like. The AVP start request is transmitted from the user terminal 200 to the back-end system 300.

In response to the AVP start request from the user, the back-end system 300 acquires information on contents (i.e., type, pattern, duration) of the first reaction and the second reaction. For example, the first reaction includes at least one of blinking a light of the vehicle 100, operating a wiper of the vehicle 100, opening and closing a side mirror of the vehicle 100, and sounding a horn of the vehicle 100. For example, the second reaction includes at least one of blinking a light (e.g., a display) of the terminal, vibrating the terminal, and outputting a sound from the terminal. The first reaction and the second reaction are associated with each other. For example, the first reaction and the second reaction may be determined in advance and associated with each other in advance. Alternatively, the back-end system 300 may determine the contents of the first reaction and the second reaction, and associate the first reaction and the second reaction with each other.

The back-end system 300 communicates with the vehicle 100 and instructs the vehicle 100 to perform the first reaction. More specifically, the back-end system 300 transmits the first reaction information RAX1 instructing the first reaction to the vehicle 100. The first reaction information RAX1 may include the content (i.e., type, pattern, duration) of the first reaction. The vehicle 100 receives the first reaction information RAX1 from the back-end system 300. The vehicle 100 performs the first reaction in accordance with the first reaction information RAX1. That is, the vehicle 100 performs the first reaction in response to the AVP start request from the user.

In addition, the back-end system 300 communicates with the terminal (i.e., at least one of the user terminal 200 and the infrastructure terminal 500) and instructs the terminal to perform the second reaction. More specifically, the back-end system 300 transmits second reaction information RAX2 instructing the second reaction to the terminal. The second reaction information RAX2 may include the content (i.e., type, pattern, duration) of the second reaction. The terminal receives the second reaction information RAX2 from the back-end system 300. The terminal performs the second reaction in accordance with the second reaction information RAX2. That is, the terminal performs the second reaction in response to the AVP start request from the user.

As described above, in response to the avp start request from the user, the back-end system 300 instructs the vehicle 100 to perform the first reaction and instructs the terminal to perform the second reaction. As a result, the vehicle 100 performs the first reaction, and the terminal performs the second reaction in conjunction with the first reaction. In other words, the vehicle 100 and the terminal link (cooperate) with each other to perform the first reaction and the second reaction, respectively.

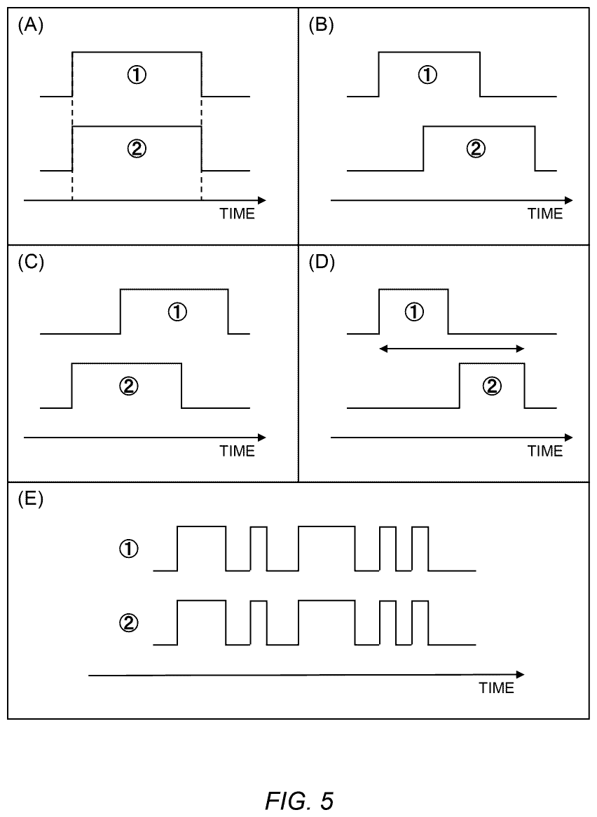

FIG. 5 is a conceptual diagram for describing various examples of the linkage between the first reaction performed by the vehicle 100 and the second reaction performed by the terminal.

In an example (A) in FIG. 5, the first reaction and the second reaction are performed in synchronization. Here, “synchronization” does not necessarily mean perfect synchronization, and may include an error due to a communication delay or an error that cannot be perceived by a human. The duration of the first reaction and the duration of the second reaction are set to be equal to each other. The back-end system 300 transmits the first reaction information RAX1 and the second reaction information RAX2 concurrently to the vehicle 100 and the terminal, respectively. As a result, the vehicle 100 performs the first reaction, and the terminal performs the second reaction in synchronization with the first reaction.

In examples (B) and (C) in FIG. 5, the duration of the first reaction and the duration of the second reaction partially overlap with each other. The first reaction may start before the second reaction or may start after the second reaction. The first reaction may end before the second reaction or may end after the second reaction. These cases are also included in the linkage between the first reaction and the second reaction.

In an example (D) in FIG. 5, the duration of the first reaction and the duration of the second reaction do not overlap, but the first reaction and the second reaction are performed in series within a short period of time (for example, 10 seconds). This case is also included in the linkage between the first reaction and the second reaction.

The type of the first reaction and the type of the second reaction may match each other. For example, the first reaction includes blinking the light of the vehicle 100, and the second reaction includes blinking the light (e.g., a display) of the terminal. As another example, the first reaction includes sounding the horn of the vehicle 100, and the second reaction includes outputting a sound from the terminal. Such the matching between the type of the first reaction and the type of the second reaction makes it possible to enhance a sense of linkage (a sense of cooperation) between the first reaction of the vehicle 100 and the second reaction of the terminal.

As illustrated in an example (E) in FIG. 5, the pattern of the first reaction and the pattern of the second reaction may match each other. For example, the first reaction includes turning on and off the light of the vehicle 100 in a predetermined pattern. The second reaction includes at least one of turning on and off the light of the terminal in the same predetermined pattern, turning on and off the vibration of the terminal in the same predetermined pattern, and turning on and off the sound output from the terminal in the same predetermined pattern. Such the matching between the pattern of the first reaction and the pattern of the second reaction makes it possible to enhance a sense of linkage (a sense of cooperation) between the first reaction of the vehicle 100 and the second reaction of the terminal.

Both the type and the pattern may match between the first reaction and the second reaction. For example, the first reaction includes turning on and off the light of the vehicle 100 in a predetermined pattern. The second reaction includes turning on and off the light of the terminal in the same predetermined pattern. Such the matching of both the type and the pattern between the first reaction and the second reaction makes it possible to further enhance the sense of linkage (the sense of cooperation) between the first reaction of the vehicle 100 and the second reaction of the terminal.

It should be noted that the AVP start request and the first reaction and the second reaction to the AVP start request have been described above just as an example. The request regarding the AVP is not limited to the AVP start request. In addition, the entity that issues the reaction instruction is not limited to the back-end system 300. The parking lot system 400 may issue the reaction instruction.

To generalize, in response to a request regarding the AVP from the user, the management system (i.e., at least one of the back-end system 300 and the parking lot system 400) instructs the vehicle 100 to perform a first reaction and instructs the terminal to perform the second reaction. In response to the request regarding the AVP from the user, the vehicle 100 performs the first reaction and the terminal performs the second reaction. In other words, the vehicle 100 performs the first reaction, and the terminal performs the second reaction in conjunction with the first reaction.

When the user is looking at the vehicle 100, the user is able to notice the first reaction of the vehicle 100. Even if the user is not looking at the vehicle 100, the user is likely to notice the second reaction of the terminal. That is, certainty that the user recognizes the reaction is improved. The user recognizing the reaction is able to recognize that the AVP system 10 has received the request. As a result, the user achieves a sense of relief and increases confidence in the AVP system 10.

### 4. Notification Of Supplementary Information

The management system may notify the terminal of supplementary information. In this case, the second reaction information RAX2 includes the supplementary information. The second reaction performed by the terminal may include displaying the supplementary information on a screen of the terminal.

### 4-1. First Example

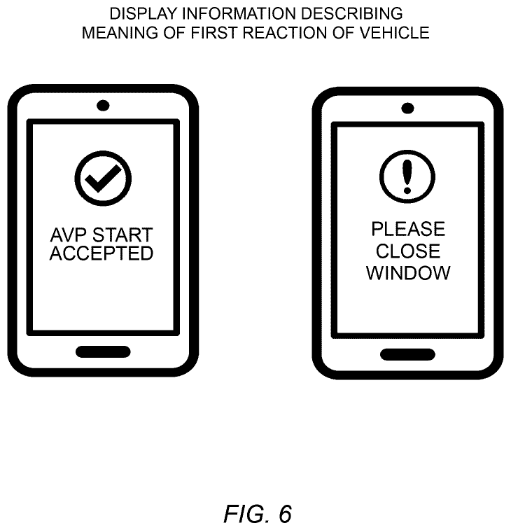

FIG. 6 is a conceptual diagram illustrating a first example of the supplementary information. Even if the vehicle 100 performs the first reaction described in the above Section 2 or Section 3, a meaning of the first reaction may not necessarily be clear to the user. Therefore, in the first example, the supplementary information includes information describing a meaning of the first reaction of the vehicle 100. The second reaction of the terminal includes displaying the information describing the meaning of the first reaction of the vehicle 100 on the screen of the terminal.

For example, in response to the AVP start request from the user, the back-end system 300 communicates with the vehicle 100 to check if a state of the vehicle 100 satisfies an AVP start condition. The AVP start condition includes, for example, that the vehicle 100 is in an ignition-OFF state, that a window is closed, that a door is closed and locked, and the like. When the state of the vehicle 100 satisfies the AVP start condition, the back-end system 300 accepts the AVP start request and proceeds to start the AVP. In this case, the first reaction is set to mean that “the AVP start request is accepted”, and the supplementary information is set to include information indicating that “the AVP start request is accepted”. On the other hand, when the state of the vehicle 100 does not satisfy the AVP start condition, the back-end system 300 rejects the AVP start request. In this case, the first reaction is set to mean that “the AVP start request is rejected”, and the supplementary information is set to include information indicating “the reason why the AVP start request is rejected” or “an operation required for accepting the AVP start request”.

As described above, according to the first example, the second reaction of the terminal includes displaying, on the screen of the terminal, the information describing the meaning of the first reaction of the vehicle 100. This enables the user to accurately understand the meaning of the first reaction of the vehicle.

### 4-2. Second Example

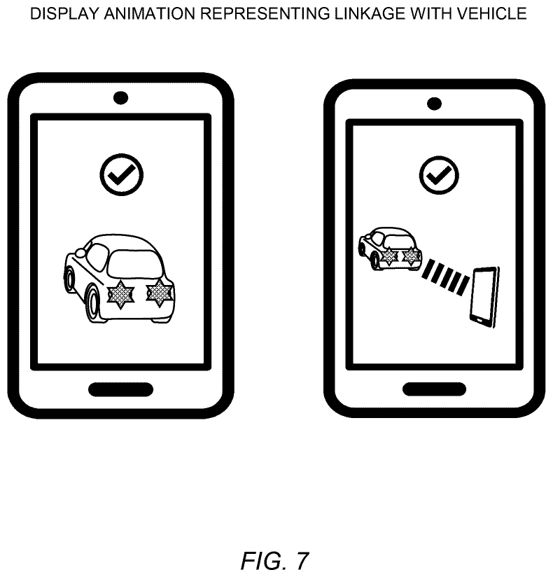

FIG. 7 is a conceptual diagram illustrating a second example of the supplementary information. The supplementary information may include an animation representing the vehicle 100 performing the first reaction. In this case, the second reaction of the terminal may include displaying the animation representing the vehicle 100 performing the first reaction on the screen of the terminal. Displaying such the animation on the terminal makes it possible to enhance a sense of linkage (a sense of cooperation) between the vehicle 100 and the terminal.

The supplementary information may include an animation representing linkage between the vehicle 100 and the terminal. In this case, the second reaction of the terminal includes displaying the animation representing linkage between the vehicle 100 and the terminal on the screen of the terminal. Displaying such the animation on the terminal makes it possible to enhance a sense of linkage (a sense of cooperation) between the vehicle 100 and the terminal.

A combination of the above-described first and second examples is also possible.

### 5. Combinations

A combination of the above-described Section 2 and Section 4 is also possible. A combination of the above-described Section 3 and Section 4 is also possible.

### 6. Configuration Example

### 6-1. Configuration Example of Vehicle

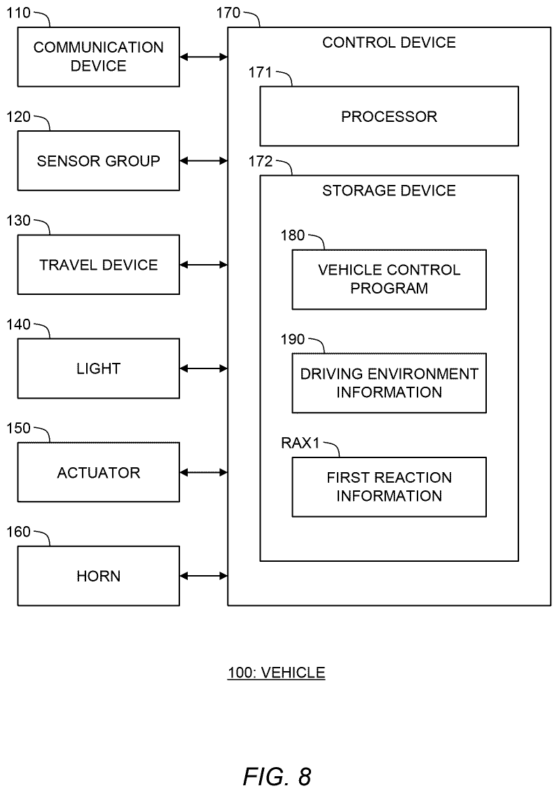

FIG. 8 is a block diagram showing a configuration example of the vehicle 100 according to the present embodiment. The vehicle 100 includes a communication device 110, a sensor group 120, a travel device 130, a light 140, an actuator 150, a horn 160, and a control device 170.

The communication device 110 communicates with the outside via a communication network. For example, the communication device 110 communicates with the back-end system 300. In addition, the communication device 110 communicates with the parking lot system 400 via a wireless LAN.

The sensor group 120 includes a recognition sensor, a vehicle state sensor, and the like. The recognition sensor is used for recognizing (detecting) a situation around the vehicle 100. Examples of the recognition sensor include a camera, a laser imaging detection and ranging (LIDAR), a radar, and the like. The vehicle state sensor includes a speed sensor, an acceleration sensor, a yaw rate sensor, a steering angle sensor, and the like.

The travel device 130 includes a steering device, a driving device, and a braking device. The steering device turns wheels. For example, the steering device includes an electric power steering (EPS) device. The driving device is a power source that generates a driving force. Examples of the driving device include an engine, an electric motor, an in-wheel motor, and the like. The braking device generates a braking force.

Examples of the light 140 include a blinker (direction indicator), a headlight, a brake light, a fog light, and the like.

Examples of the actuator 150 include a wiper actuator that operates a wiper, an actuator for automatically opening and closing a side mirror, and the like.

The horn 160 outputs a sound.

The control device 170 is a computer that controls the vehicle 100. The control device 170 includes one or more processors 171 (hereinafter, simply referred to as a processor 171) and one or more storage devices 172 (hereinafter, simply referred to as a storage device 172). The processor 171 executes a variety of processing. Examples of the processor 171 include a general-purpose processor, a special-purpose processor, a central processing unit (CPU), a graphics processing unit (GPU), an application specific integrated circuit (ASIC), a field-programmable gate array (FPGA), an integrated circuit, and / or a combination thereof. The processor 171 may also be referred to as processing circuitry. The storage device 172 stores a variety of information. Examples of the storage device 172 include a volatile memory, a nonvolatile memory, a hard disk drive (HDD), a solid state drive (SSD), and the like.

A vehicle control program 180 is a computer program for controlling the vehicle 100. The functions of the control device 170 may be realized by a cooperation between the processor 171 executing the vehicle control program 180 and the storage device 172. The vehicle control program 180 is stored in the storage device 172. Alternatively, the vehicle control program 180 may be recorded on a non-transitory computer-readable recording medium.

The control device 170 executes vehicle travel control for controlling travel of the vehicle 100. The vehicle travel control includes steering control, acceleration control, and deceleration control. The control device 170 executes the vehicle travel control by controlling the travel device 130 (i.e., the steering device, the driving device, and the braking device).

The control device 170 communicates with the back-end system 300 and the parking lot system 400 via the communication device 110.

The control device 170 acquires driving environment information 190 indicating a driving environment for the vehicle 100. The driving environment information 190 is stored in the storage device 172. For example, the driving environment information 190 includes surrounding situation information, vehicle state information, map information, position information, and the like.

The surrounding situation information indicates the result of recognition by the recognition sensor. The surrounding situation information may include object information regarding an object recognized by the recognition sensor. Examples of the object around the vehicle 100 include an obstacle, a white line, a marker M, and the like. Examples of the obstacle include a wall, a pillar, another vehicle, and the like. The object information indicates a relative position and a relative speed of the object with respect to the vehicle 100.

The vehicle state information indicates the vehicle state detected by the vehicle state sensor. Examples of the vehicle state include a speed, an acceleration, a yaw rate, a steering angle, and the like.

The map information is map information of the parking lot in which the vehicle 100 travels. The map information indicates an arrangement of roads in the parking lot. In addition, the map information indicates an arrangement of stationary obstacles (for example, walls and pillars) in the parking lot. The map information further indicates an arrangement of the markers M in the parking lot. For example, the map information is provided from the parking lot system 400 that manages the parking lot. The control device 170 acquires the map information from the parking lot system 400 via the communication device 110.

Position information indicates a current position of the vehicle 100 in the parking lot. For example, the control device 170 acquires the position information with high accuracy by performing localization processing (Localization). More specifically, the control device 170 calculates a rough position of the vehicle 100 in the parking lot based on the vehicle state information (specifically, the steering angle and the speed). Moreover, the control device 170 recognizes the marker M around the vehicle 100 by using the recognition sensor. In addition, the control device 170 acquires the arrangement information of the markers M around the vehicle 100 from the map information. The control device 170 corrects the position of the vehicle 100 by matching the recognition result of the marker M with the arrangement of the markers M. Accordingly, the position information with high accuracy is obtained.

Alternatively, the position information of the vehicle 100 may be estimated by the parking lot system 400 based on the image captured by the infrastructure camera CAM. In this case, the control device 170 may acquire the position information from the parking lot system 400 via the communication device 110.

The control device 170 acquires information on the travel path TP in the parking lot. For example, the travel path TP is determined by the parking lot system 400, and the control device 170 acquires information on the travel path TP from the parking lot system 400 via the communication device 110. As another example, the control device 170 may determine the travel path TP based on the map information and the position information. Then, the control device 170 executes the vehicle travel control based on the position information such that the vehicle 100 travels along the travel path TP.

The control device 170 acquires the first reaction information RAX1 from the back-end system 300 or the parking lot system 400 via the communication device 110. The first reaction information RAX1 may indicate the content of the first reaction. For example, the first reaction includes at least one of blinking the light 140, operating the wiper, opening and closing the side mirror, and sounding the horn 160. The control device 170 executes the first reaction in accordance with the first reaction information RAX1.

### 6-2. Configuration Example of User Terminal

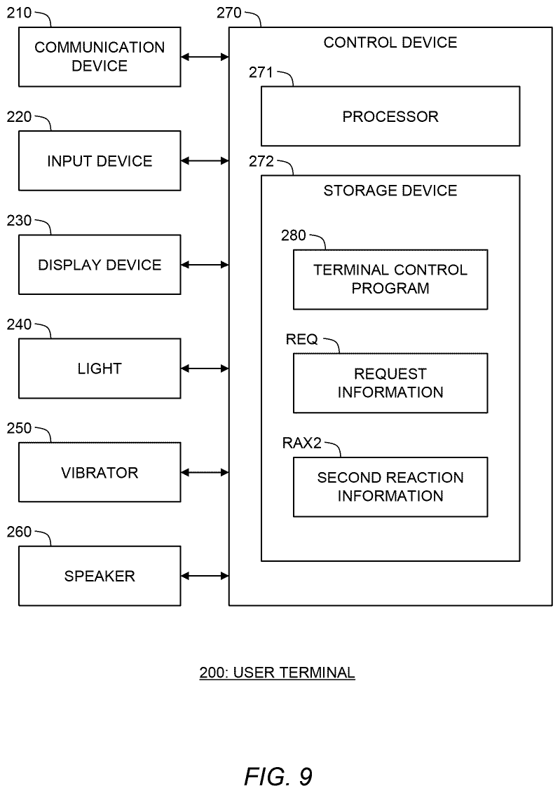

FIG. 9 is a block diagram illustrating a configuration example of the user terminal 200 according to the present embodiment. The user terminal 200 includes a communication device 210, an input device 220, a display device 230, a light 240, a vibrator 250, a speaker 260, and a control device 270.

The communication device 210 communicates with the outside via a communication network. For example, the communication device 210 communicates with the back-end system 300.

Examples of the input device 220 include a touch panel, a button, a microphone, and the like.

Examples of the display device 230 include a touch panel, a display, and the like. The display device 230 and the input device 220 may be the same touch panel.

Examples of the light 240 include a touch panel, a display, and the like. The light 240 may be the same as the display device 230.

The vibrator 250 vibrates the user terminal 200.

The speaker 260 outputs a sound.

The control device 270 is a computer that controls the user terminal 200. The control device 270 includes one or more processors 271 (hereinafter, simply referred to as a processor 271) and one or more storage devices 272 (hereinafter, simply referred to as a storage device 272). The processor 271 executes a variety of processing. Examples of the processor 271 include a general purpose processor, a special purpose processor, a CPU, a GPU, an ASIC, an FPGA, an integrated circuit, and/or combinations thereof. The processor 271 may also be referred to as processing circuitry. The storage device 272 stores a variety of information. Examples of the storage device 272 include a volatile memory, a nonvolatile memory, an HDD, an SSD, and the like.

A terminal control program 280 is a computer program for controlling the user terminal 200. The terminal control program 280 includes an AVP application. The functions of the control device 270 may be realized by a cooperation between the processor 271 executing the terminal control program 280 and the storage device 272. The terminal control program 280 is stored in the storage device 272. Alternatively, the terminal control program 280 may be recorded on a non-transitory computer-readable recording medium.

The user is able to input the request regarding the AVP by the use of the input device 220. A request information REQ indicates the request input by the user. For example, the input device 220 and the display device 230 are configured by a touch panel. At the parking area, the user opens the AVP application. An “AVP Start” button is displayed on the touch panel. When the user taps the “AVP Start” button, the request information REQ including the AVP start request is generated. The control device 270 transmits the request information REQ to the management system via the communication device 210.

Moreover, the control device 270 acquires the second reaction information RAX2 from the back-end system 300 or the parking lot system 400 via the communication device 210. The second reaction information RAX2 may indicate the content of the second reaction. For example, the second reaction includes at least one of blinking the light 240, operating the vibrator 250 to vibrate the user terminal 200, and outputting a sound from the speaker 260. The control device 270 executes the second reaction in accordance with the second reaction information RAX2.

The second reaction information RAX2 may include the supplementary information described in the above Section 4. In this case, the control device 270 displays the supplementary information on the display device 230.

It should be noted that the infrastructure terminal 500 also has a configuration equivalent to that of the user terminal 200.

### 6-3. Configuration Example of Back-End System

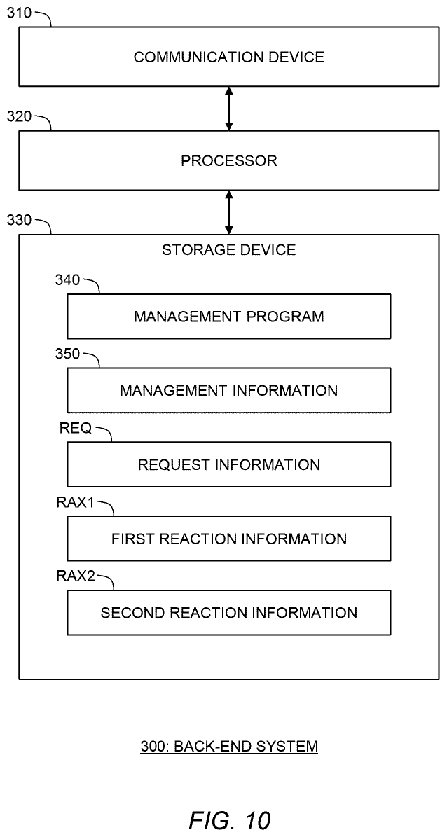

FIG. 10 is a block diagram showing a configuration example of the back-end system 300 according to the present embodiment. The back-end system 300 includes a communication device 310, one or more processors 320 (hereinafter simply referred to as a processor 320), and one or more storage devices 330 (hereinafter simply referred to as a storage device 330).

The communication device 310 communicates with each vehicle 100. In addition, the communication device 310 communicates with the user terminal 200 of each user. Further, the communication device 310 communicates with the parking lot system 400 of each parking lot. Further, the communication device 310 may communicate with the infrastructure terminal 500 via the parking lot system 400.

The processor 320 executes a variety of processing. Examples of the processor 320 include a general purpose processor, a special purpose processor, a CPU, a GPU, an ASIC, an FPGA, an integrated circuit, and/or combinations thereof. The processor 320 may also be referred to as processing circuitry. The storage device 330 stores a variety of information. Examples of the storage device 330 include a volatile memory, a nonvolatile memory, an HDD, an SSD, and the like.

A management program 340 is a computer program for managing the AVP in the parking lot. The functions of the back-end system 300 may be realized by a cooperation between the processor 320 executing the management program 340 and the storage device 330. The management program 340 is stored in the storage device 330. The management program 340 may be recorded on a non-transitory computer-readable recording medium.

The storage device 330 stores management information 350. The management information 350 may include the user information and the reservation information regarding each user. The management information 350 may include facility information and reservation status information regarding each parking lot. When the processor 320 receives the reservation request information from the user, the processor 102 may perform a reservation process based on the management information 350.

The processor 320 receives the request information REQ from the user terminal 200 via the communication device 310. The request information REQ is stored in the storage device 330.

In response to the request information REQ, the processor 320 acquires the first reaction information RAX1 and the second reaction information RAX2. The first reaction information RAX1 instructs the vehicle 100 to perform the first reaction. The first reaction information RAX1 may include the content of the first reaction. The second reaction information RAX2 instructs the terminal (i.e., at least one of the user terminal 200 and the infrastructure terminal 500) to perform the second reaction. The second reaction information RAX2 may include the content of the second reaction. The second reaction information RAX2 may include the supplementary information described in the above Section 4. The processor 320 transmits the first reaction information RAX1 to the vehicle 100 and transmits the second reaction information RAX2 to the terminal via the communication device 310.

### 6-4. Configuration Example of Parking Lot System

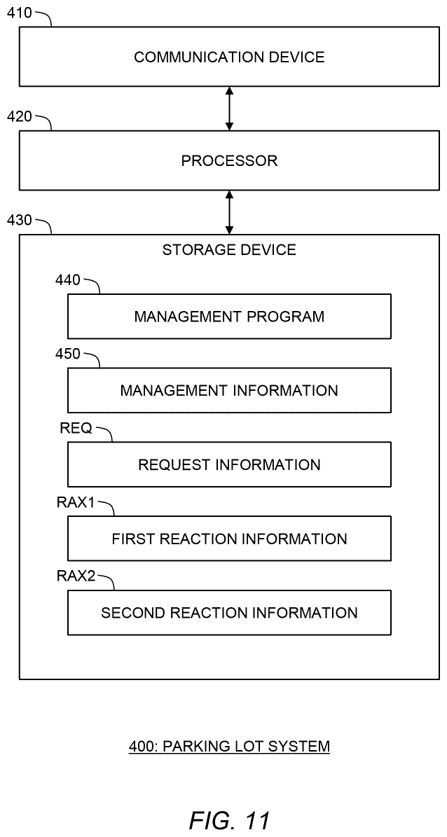

FIG. 11 is a block diagram showing a configuration example of the parking lot system 400 according to the present embodiment. The parking lot system 400 includes a communication device 410, one or more processors 420 (hereinafter simply referred to as a processor 420), and one or more storage devices 430 (hereinafter simply referred to as a storage device 430).

The communication device 410 communicates with each vehicle 100. In addition, the communication device 410 communicates with the back-end system 300. Further, the communication device 410 may communicate with the infrastructure camera CAM installed in the parking lot.

The processor 420 executes a variety of processing. Examples of the processor 420 include a general purpose processor, a special purpose processor, a CPU, a GPU, an ASIC, an FPGA, an integrated circuit, and / or combinations thereof. The processor 420 may also be referred to as processing circuitry. The storage device 430 stores a variety of information. Examples of the storage device 430 include a volatile memory, a nonvolatile memory, an HDD, an SSD, and the like.

A management program 440 is a computer program for managing the parking lot. The functions of the parking lot system 400 may be realized by a cooperation between the processor 420 executing the management program 440 and the storage device 430. The management program 440 is stored in the storage device 430. The management program 440 may be recorded on a non-transitory computer-readable recording medium.

The processor 420 communicates with the vehicle 100 and the back-end system 300 via the communication device 410.

The storage device 430 stores management information 450 for managing the parking lot. The management information 450 includes the map information of the parking lot. The processor 420 may provide the map information to the vehicle 100 via the communication device 410. Moreover, the management information 450 indicates a usage status (vacancy status) of the parking spaces in the parking lot. The processor 420 can allocate an available parking space (destination) to the vehicle 100 based on the management information 450.

The management information 450 may further include vehicle management information. The vehicle management information includes the position information of each vehicle 100 in the parking lot. The processor 420 may communicate with each vehicle 100 via the communication device 410 and collect the position information from each vehicle 100. Alternatively, the processor 420 may acquire the image captured by the infrastructure camera CAM installed in the parking lot and estimate the position of each vehicle 100 based on the image. The vehicle management information may include the travel path TP allocated to each vehicle 100. The processor 420 can determine the travel path TP allocated to each vehicle 100 based on the position information 174 the vehicle 100, the destination, and the map information. The processor 420 may provide the information on the travel path TP to the vehicle 100 via the communication device 410.

The processor 420 may receive the request information REQ from the user terminal 200 via the back-end system 300 and the communication device 410. The request information REQ is stored in the storage device 430.

In response to the request information REQ, the processor 420 acquires the first reaction information RAX1 and the second reaction information RAX2. The first reaction information RAX1 instructs the vehicle 100 to perform the first reaction. The first reaction information RAX1 may include the content of the first reaction. The second reaction information RAX2 instructs the terminal (i.e., at least one of the user terminal 200 and the infrastructure terminal 500) to perform the second reaction. The second reaction information RAX2 may include the content of the second reaction. The second reaction information RAX2 may include the supplementary information described in the above Section 4. The processor 420 transmits the first reaction information RAX1 to the vehicle 100 via the communication device 410. In addition, the processor 420 transmits the second reaction information RAX2 to the user device 200 via the communication device 410 and the back-end system 300. The processor 420 may transmit the second reaction information RAX2 to the infrastructure terminal 500.

What is claimed is:

1. A management system that manages automated valet parking of a vehicle in a parking lot,
the management system comprising processing circuitry, wherein a terminal includes at least one of a user terminal of a user of the vehicle and an infrastructure terminal installed in the parking lot,
the processing circuitry is configured to:
receive a request regarding the automated valet parking of the vehicle from the user terminal; and
in response to the request, instruct the vehicle to perform a first reaction and instruct the terminal to perform a second reaction.

2. The management system according to claim 1, wherein
the first reaction includes at least one of blinking a light of the vehicle, operating a wiper of the vehicle, opening and closing a side mirror of the vehicle, and sounding a horn of the vehicle, and
the second reaction includes at least one of blinking a light of the terminal, vibrating the terminal, and outputting a sound from the terminal.

3. The management system according to claim 1, wherein the first reaction includes blinking a light of the vehicle, and the second reaction includes blinking a light of the terminal.

4. The management system according to claim 1, wherein
the first reaction includes turning on and off a light of the vehicle in a predetermined pattern, and
the second reaction includes at least one of turning on and off a light of the terminal in the predetermined pattern, turning on and off vibration of the terminal in the predetermined pattern, and turning on and off a sound output from the terminal in the predetermined pattern.

5. The management system according to claim 1, wherein
the first reaction includes turning on and off a light of the vehicle in a predetermined pattern, and
the second reaction includes turning on and off a light of the terminal in the predetermined pattern.

6. The management system according to claim 1, wherein
the second reaction includes displaying an animation representing the vehicle performing the first reaction on a screen of the terminal.

7. The management system according to claim 1, wherein
the second reaction includes displaying an animation representing linkage between the vehicle and the terminal on a screen of the terminal.

8. The management system according to claim 1, wherein
the second reaction includes displaying information describing a meaning of the first reaction of the vehicle on a screen of the terminal.

9. The management system according to claim 1, wherein the request is one for starting the automated valet parking of the vehicle.

10. An automated valet parking system comprising:
a vehicle that is a target of automated valet parking in a parking lot;
a terminal including at least one of a user terminal of a user of the vehicle and an infrastructure terminal installed in the parking lot, wherein
in response to a request regarding the automated valet parking of the vehicle from the user, the vehicle performs a first reaction, and the terminal performs a second reaction.
